(19) United States
(12) Patent Application Publication
(10) Pub. No.: US 2004/0256186 A1
(43) Pub. Date: Dec. 23, 2004

(54) Spring-less monotube shock absorber

(76) Inventor: Ronald Wayne Farewell, Mississauga (CA)

Correspondence Address: CARLSON, GASKEY & OLDS, P.C., 400 WEST MAPLE ROAD, SUITE 350, BIRMINGHAM, MI, 48009, US

(21) Appl. No.: 10/464,191

(22) Filed: Jun. 18, 2003

(51) Int. Cl. F16F 9/00

(52) U.S. Cl. 188/314

(57) ABSTRACT

A damper assembly includes a damper chamber and a remote reservoir chamber. The remote reservoir chamber includes a floating piston. The floating piston moves within a reservoir cavity to accommodate the additional fluid volume from a shaft during the compression strokes. The floating piston separates a fluid chamber which receives a hydraulic fluid from the damping chamber and a compressible fluid chamber which contains a compressible fluid. The compressible fluid provides a much higher compression ratio than conventional gas chambers and thereby operates as a bias to compress the fluid chamber and operate as a spring.

### BACKGROUND OF THE INVENTION

The present invention relates to a shock absorber with a remote reservoir fluid chamber, and more particularly to a monotube shock absorber with a remote reservoir fluid chamber which replaces a heretofore required coil spring.

Many conventional monotube shock absorbers include a reservoir chamber having a quantity of fluid in communication with a main chamber of the shock absorber. The main chamber of the shock absorber includes a piston that divides the chamber and controls the fluid flow between sections of the chamber. The fluid reservoir increases or decreases the hydraulic fluid to the main chamber in response to movement of the piston within the main damper chamber.

The reservoir allows the main damper chamber to be constructed shorter than normally would be allowed and may allow the use of a larger shaft that connects the piston and damper assembly to one of the mounting members of the damper assembly. The shaft takes up volume within the damper assembly and the larger diameter of the shaft reduces the volume available for the storage of hydraulic fluid in the main chamber. For these reasons, it has been found desirable to provide remote reservoir chamber to separate additional fluid volume from the gas.

A coil spring or other biasing member is typically located about the shock absorber to provide for rebound of the shock after a compression event. Although effective, the coil spring is a relatively expensive component or considerable weight. For some vehicle applications, such as snowmobile shock absorbers, such a spring may increase the unit cost of the shock absorber considerably.

Accordingly, it is desirable to provide a remote reservoir chamber for a damper assembly that eliminates the requirement for a spring.

### SUMMARY OF THE INVENTION

The damper assembly of this invention includes a damper chamber and a remote reservoir chamber. The remote reservoir chamber includes a floating piston. The floating piston moves within a reservoir cavity to accommodate the additional volume of the shaft during the compression and rebound strokes. The floating piston separates a fluid chamber which receives a hydraulic fluid from the damping chamber and a compressible fluid chamber which contains a compressible fluid. The compressible fluid provides a much higher compression ratio than conventional gas chambers and thereby operates as a bias to compress the fluid chamber and operate as a spring.

An air bladder may be provided within the compressible fluid. The air bladder reduces the volume of compressible fluid required to fill the compressible fluid chamber. Typically, a reduction of the air bladder will require a larger compressible fluid chamber to achieve the same compression ratio. The relative compression ratio provided by the compressible fluid may therefore be adjusted in relation to the relative volume of compressible fluid and the volume of the air bladder.

The present invention therefore provides a remote reservoir chamber for a damper assembly that eliminates the requirement for a spring.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of a snowmobile depicting a rear shock absorber in phantom; and

FIG. 2 is a general partial sectional view of a monotube shock absorber.

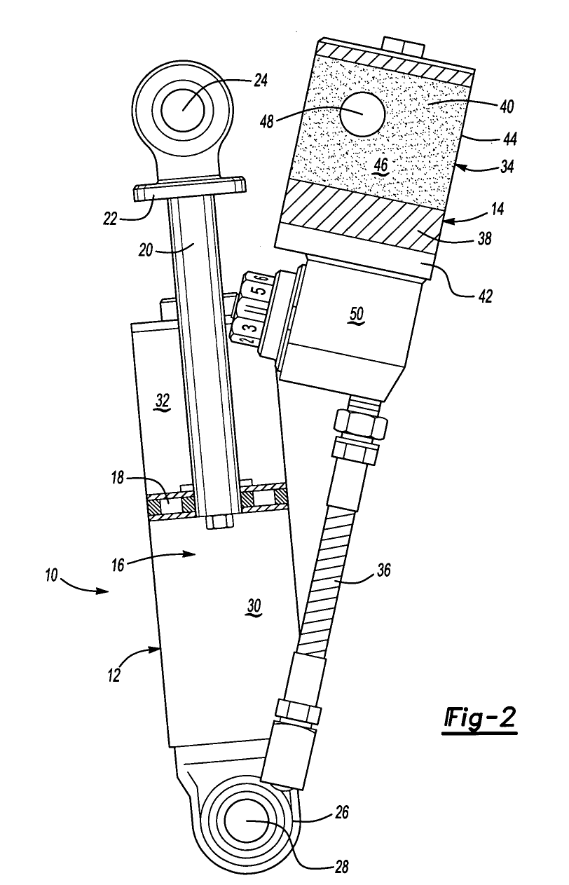

### DETAILED DESCRIPTION OF THE PREFERRED EMBODIMENT

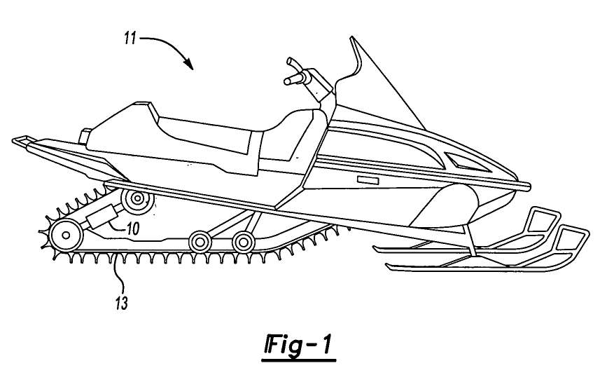

FIG. 1 illustrates a general perspective view of a damper assembly 10 for a vehicle such as a snowmobile 11. The damper assembly 10 connects tracks 13 to the body of the snowmobile 11 by suspension linkages for damping inputs from the roadway. The present invention adjustable shock absorber is desirable for snowmobile applications, and most desirable for rear shock absorbers for snowmobiles. However, it is to be understood that the adjustable shock absorber may be utilized for any number of other applications.

The damper assembly 10 includes a first housing 12 and a second housing 14. The first housing 12 defines a damper chamber 16. The damper chamber 16 includes a piston 18 attached to a shaft 20. The shaft 20 extends from the damper chamber 16 for mounting of the damper assembly 10 through an end cap 22 having an aperture 24. The opposite end of the housing 12 includes another end cap 26 with a mounting aperture 28.

The piston 18 divides the chamber 16 into compression 30 and rebound 32 chambers. The piston 18 moves within the chamber 16 dampening oscillations between two suspension members connected to the end caps 22, 26 which are movable relative to each other. As appreciated, various mounting arrangements of the damper assembly 10 will benefit from the instant invention.

The damping chamber 16 is in fluid communication with a remote reservoir chamber 34 through a conduit 36 or the like. Conduit 36 is preferably a flexible braided steel hose or tubing, however, other fluid communication paths will also benefit from the present invention. The remote reservoir chamber 34 is defined by the second housing 14. The second housing 14 may be remotely located from the first housing 12.

The remote reservoir chamber 34 includes a floating piston 38. The floating piston 38 moves within a reservoir cavity 40 to accommodate the additional volume of the shaft 20 during the compression and rebound strokes. The floating piston 38 also separates a fluid chamber 42 which receives a hydraulic fluid within the damping chamber 16 and a compressible fluid chamber 44 which contains a compressible fluid 46. The compressible fluid is preferably an oil and air mixture. That is, the oil contains small beads of air, thus allowing for the compressibility. It should be understood that various compressible fluids will benefit from the instant invention. The compressible fluid 46 provides a much higher compression ratio than conventional gas chambers and thereby operates as a bias to compress the hydraulic fluid within the fluid chamber 42.

An air bladder 48 is provided within the compressible fluid 46. The air bladder 48 reduces the volume of compressible fluid 46 required to fill the compressible fluid chamber 44. The air volume inside the bladder 48, combined with the total volume of all the air beads, is large enough to accept the total rod volume. Other than these two sources of air, the remainder of the oil in the shock is incompressible. Without an air bladder, 48 the compressible fluid itself would not contain enough air volume. Typically, a reduction of the air bladder will require a larger compressible fluid chamber 44 to achieve the same compression ratio. The relative compression ratio provided by the compressible fluid 46 may therefore be adjusted in relation to the relative volume of compressible fluid 46 and the volume of the air bladder 48. That is, the overall compression ratio and thus the spring force may be adjusted for particular applications.

An adjustment member 50 may be located in fluid communication with the remote reservoir chamber 34 to permit adjustment of the damping characteristics of the damper 10, and in turn, adjustment of the ride handling characteristics of the snowmobile. The floating piston 38 responsiveness is preferably adjusted by modifying fluid flow between the damper chamber 16 and the fluid chamber 42 by varying the adjustment member 50 as generally known.

Through the elimination of the coil spring an extremely inexpensive and compact shock absorber of reduced weight is thereby provided by the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. (CURRENTLY AMENDED)A damper assembly comprising;
a first housing comprising a first chamber containing a hydraulic fluid and a first piston secured to a rod extending from said first chamber;
a second housing comprising a second chamber and a third chamber separated by a second piston, said second piston separating said a hydraulic fluid within said second chamber from a compressible fluid liquid within said third chamber; and
a fluid passage communicating hydraulic fluid between said first and second chambers in response to movement of said first piston within said first chamber.

2. (CANCELED)

3. (CURRENTLY AMENDED) The damper assembly as recited in claim 1, further comprising an air bladder within said compressible fluid liquid.

4. (CURRENTLY AMENDED) The damper assembly as recited in claim 1, wherein said compressible fluid liquid provides a compression ratio greater than 200 pounds.

5. (ORIGINAL) The damper assembly as recited in claim 1, wherein said second housing is located remote from said first housing.

6. (ORIGINAL) The damper assembly as recited in claim 1, wherein said fluid passage comprises a conduit.

7. (CURRENTLY AMENDED) A method of providing a rebound force for a monotube shock absorber comprising the steps of:
(1) separating a hydraulic fluid from a compressible fluid liquid within a remote reservoir;
(2) compressing the compressible fluid liquid in response to compression of the monotube shock absorber; and
(3) extending the monotube shock absorber in response to decompression of the compressible fluid liquid within the reservoir.

8. (CURRENTLY AMENDED) A method as recited in claim 7, wherein said step (2) further comprises compressing an air bladder within the compressible fluid liquid.

9. (NEW) The damper assembly as recited in claim 1, further comprising an air bladder surrounded by said compressible liquid.

10. (NEW) The damper assembly as recited in claim 1, further comprising an air bladder freely located within a compressible fluid chamber which contains said compressible liquid.

11. (NEW) The damper assembly as recited in claim 1, further comprising an air bladder at least partially submerged within said compressible liquid.

12. (NEW) The damper assembly as recited in claim 1, wherein said compressible fluid includes an oil and air mixture.

13. (NEW) The damper assembly as recited in claim 1, wherein said rod and said first chamber, respectively, are adapted to connect a snowmobile track to a snowmobile body.

14. (NEW) A method as recited in claim 7, further comprising the steps of:
locating an air bladder within the compressible liquid; and
compressing the air bladder within the compressible liquid during said step (2).

15. (NEW) A method as recited in claim 7, further comprising the steps of:
floating an air bladder within the compressible liquid; and
compressing the air bladder within the compressible liquid during said step (2).

16. (NEW) A damper assembly comprising;
a first housing comprising a first chamber containing a hydraulic fluid and a first piston secured to a rod extending from said first chamber;
a second housing comprising a second chamber and a third chamber separated by a second piston, said second piston separating a hydraulic fluid within said second chamber from a compressible liquid within said third chamber;
an air bladder at least partially submerged within said compressible liquid; and
a fluid passage communicating hydraulic fluid between said first and second chambers in response to movement of said first piston within said first chamber.

17. (NEW) The damper assembly as recited in claim 16, wherein said rod and said first chamber, respectively, are adapted to connect a snowmobile track to a snowmobile body.

18. (NEW) The damper assembly as recited in claim 16, wherein said compressible fluid includes an oil and air mixture.

19. (NEW) The damper assembly as recited in claim 16, wherein said air bladder is freely located within said third chamber.
